(19) United States
(12) Patent Application Publication
(10) Pub. No.: US 2026/0099679 A1
(43) Pub. Date: Apr. 9, 2026

(54) HYBRID LANGUAGE MODEL FOR PLANNING VIA ENCODER MODELS AND GRAPH SEARCH ALGORITHMS

(71) Applicant: International Business Machines Corporation, Armonk, NY (US)

(72) Inventors: Eran Hirsch, Kfar Saba (IL); Guy Uziel, Rishon Lezion (IL); Ateret Anaby - Tavor, Givat Ada (IL)

(21) Appl. No.: 18/910,587

(22) Filed: Oct. 9, 2024

(51) Int. Cl. G06F 40/40

(52) U.S. Cl. CPC G06F 40/40

(57) ABSTRACT

One or more systems, devices, computer program products and/or computer-implemented methods of use provided herein relate to a hybrid language model with an encoder model and graph search algorithm for planning problems. For example, a system can comprise a memory that can store computer executable components and a processor that executes at least one of the computer executable components that can receive a current state, a set of applicable actions, and a set of goal states that define a planning problem. The at least one of the computer executable components can further generate, via a language model, a plan for the planning problem, wherein generating the plan for the planning problem can comprise: generating, via an encoder, respective encoded representations of the current state, the set of applicable actions and evaluating, via a graph search algorithm, a set of plans based on the encoded representations.

### BACKGROUND

The subject disclosure relates to planning problems and, more specifically, to a hybrid language model (LM) for planning via encoder models and graph search algorithms.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable a hybrid language model for planning via encoder models and graph search algorithms are discussed.

According to an embodiment, a system is provided. The system can comprise a memory that can store computer executable components. The system can further comprise a processor that can execute at least one of the computer executable components that can receive a current state, a set of applicable actions, and a set of goal states that define a planning problem. The at least one of the computer executable components can further generate, via a language model, a plan for the planning problem, wherein generating the plan for the planning problem can comprise: generating, via an encoder, respective encoded representations of the current state, the set of applicable actions and evaluating, via a graph search algorithm, a set of plans based on the encoded representations.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate planning via a hybrid language model with encoder models and graph search algorithms in accordance with one or more embodiments described herein.

FIG. 2 illustrates another block diagram of an example, non-limiting system that can facilitate planning via a hybrid language model with encoder models and graph search algorithms in accordance with one or more embodiments described herein.

FIG. 3 illustrates diagrams of example, non-limiting problem domain and problem instance in accordance with one or more embodiments described herein.

FIG. 4 illustrates a diagram of example, non-limiting encoder architecture of the hybrid language model in accordance with one or more embodiments described herein.

FIG. 5 illustrates a diagram of example, non-limiting graph search algorithm used by the hybrid language model in accordance with one or more embodiments described herein.

FIG. 6 illustrates an example, non-limiting block diagram showing conversion of applicable actions into action effects in accordance with one or more embodiments described herein.

FIG. 7 illustrates an example, non-limiting block diagram showing generation of a plan for a planning problem in accordance with one or more embodiments described herein.

FIG. 8 illustrates a diagram of example, non-limiting planning algorithm via a hybrid language model in accordance with one or more embodiments described herein.

FIG. 9 illustrates a diagram of example, non-limiting experiment setup of the hybrid language model and existing methods in accordance with one or more embodiments described herein.

FIG. 10 illustrates diagrams of example, non-limiting experiment results of the hybrid language model and existing methods in accordance with one or more embodiments described herein.

FIG. 11 illustrates a flow diagram of an example, non-limiting method that can facilitate planning via a hybrid language model with encoder models and graph search algorithms in accordance with one or more embodiments described herein.

FIG. 12 illustrates a flow diagram of an example, non-limiting method that can facilitate planning via a hybrid language model with encoder models and graph search algorithms in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute at least one of the computer executable components that can receive a current state, a set of applicable actions, and a set of goal states that define a planning problem. The at least one of the computer executable components can further generate, via a language model (LM), a plan for the planning problem, wherein generating the plan for the planning problem can comprise: generating, via an encoder, respective encoded representations of the current state, the set of applicable actions and evaluating, via a graph search algorithm, a set of plans based on the encoded representations.

Such embodiments of the system can provide a number of advantages, including enhancing the ability of LM-based planners to generalize to more complex problems when training on simpler problems, simplifying planning tasks for LM-based planners by removing the need to generate actions, improving computational efficiency in generating plans, and improving prediction accuracy of LM-based planners.

In one or more embodiments of the aforementioned system, the encoder can be a bi-decoder that generates the respective encoded representations of the set of applicable actions separate from the respective encoded representations of the current state and the set of goal states.

Such embodiments of the system can provide the advantage of improving computational efficiency of LM-based planners by enabling one-time encoding of the set of applicable actions.

In one or more embodiments of the aforementioned system, the encoder can generate the respective encoded representations of the set of applicable actions in an offline process and store the respective encoded representations of the set of applicable actions for subsequent use.

Such embodiments of the system can provide a number of advantages, improving computational efficiency of LM-based planners by pre-computing the encoded representations of the set of applicable actions offline and enabling one-time encoding by storing them for subsequent use, and reducing inferencing time of LM-based planners.

In one or more embodiments of the aforementioned system, at least one of the computer executable components can further determine, using a similarity function, respective scores the set of applicable actions based on a similarity to the current state or the set of goal states.

Such embodiments of the system can provide a number of advantages, including improving prediction accuracy of LM-based planners by enabling ranking of applicable actions and improving computational efficiency LM-based planners when evaluating a large number of applicable actions.

In one or more embodiments of the aforementioned system, at least one of the computer executable components can further insert the set of applicable actions with the respective scores into a prioritized queue. At least one of the computer executable components can further select a next applicable action based on a maximum score of the respective scores.

Such embodiments of the system can provide a number of advantages, including enabling the LM-based planner to jump states from different stages of inference based on heuristic values, improving efficiency of exploration of the search space, enabling flexibility in path selection, and enabling effective error recovery.

In one or more embodiments of the aforementioned system, at least one of the computer executable components can further determine respective heuristic values of the set of plans based on the respective scores of the set of applicable actions to evaluate the set of plans for determining the next applicable action. At least one of the computer executable components can further apply a cost function to respective heuristic values of the set of plans.

Such embodiments of the system can provide a number of advantages, including reducing inherent biases against longer sequences and promoting broader exploration of high-potential paths to enhance performance in complex planning tasks.

In one or more embodiments of the aforementioned system, at least one of the computer executable components can further convert the set of applicable actions into a set of action effects. At least one of the computer executable components can further encode the current state, the set of goal states, or the set of action effects into predicates. At least one of the computer executable components can further generate, via the encoder, the respective encoded representations from the predicates.

Such embodiments of the system can provide a number of advantages, including reducing a logical step for LM-based planners and simplifying interaction between the environment and the LM-based planners.

In one or more embodiments of the aforementioned system, the graph search algorithm can select states for exploration from the prioritized queue based on the respective heuristic values of the set of plans.

Such embodiments of the system can provide a number of advantages, allowing LM-based planners to explore multiple states concurrently by retrieving multiple states from the prioritized queue and allowing for more comprehensive exploration of particularly high-potential states.

In one or more embodiments of the aforementioned system, at least one of the computer executable components can further unify the predicates of the current state and the predicates of the set of goal states to represent a problem instance of the planning problem.

In one or more embodiments of the aforementioned system, at least one of the computer executable components can further linearize the predicates of the set of action effects. At least one of the computer executable components can further linearize the problem instance. Linearizing the problem instance can comprise shuffling the predicates of the current state with the predicates of the set of goal states. Linearizing the problem instance can further comprise converting the predicates into tokens.

Such embodiments of the system can provide an advantage of enabling training on simple planning problems for generalizing to more complex planning problems.

In one or more embodiments of the aforementioned system, at least one of the computer executable components can select an action from a retrieval pool that comprises the set of applicable actions.

Such embodiments of the system can provide a number of advantages, including constraining LM-based planners to select valid actions and improving decision-making of LM-based planners of the actions.

In one or more embodiments of the aforementioned system, at least one of the computer executable components can select an action with a maximum score from the respective scores of the set of applicable actions based on a subset of query tokens representing the problem instance. At least one of the computer executable components can further compare the action with a ground-truth action using a contrastive loss function to train the language model.

Such embodiments of the system can provide the advantage of allowing LM-based planners to learn from both correct (ground-truth) and incorrect (predicted) actions, thus enhancing of performance LM-based planners.

According to various embodiments, the above-described system can be implemented as a computer-implemented method or as a computer program product.

### Definitions

Planning Problem: A planning problem refers to a task of finding a sequence of actions that transitions an initial state to a desired goal state, given a set of possible actions and constraints.

Large language model (LLM): An LLM is an artificial intelligence model trained on vast amounts of text data to understand, generate, and manipulate human language, enabling it to perform tasks such as language translation, summarization, and question answering.

Graph Search Algorithm: A graph search algorithm is a method for systematically exploring possible options or paths in a problem space to find a solution.

Prioritized Queue: A Prioritized Queue is a data structure that organizes elements based on priority.

Contrastive Learning: Contrastive learning refers to a training approach where a model learns to differentiate between similar and dissimilar pairs to improve its understanding of relationships.

Encoder model: An encoder model is a neural network model that transforms input data into a structured representation or vector embedding that captures features and relationships for downstream tasks.

Planning is a fundamental aspect of artificial intelligence and computer science that involves determining a sequence of actions to transition from an initial state to a desired goal state. In classical planning, this problem is typically represented using symbolic languages that encode information about the domain and the specific problem instance. For example, in a common domain referred to as the ferry domain, a typical problem might involve transporting cars between locations using a ferry. The initial state specifies the locations of the cars and the ferry, and the goal can be to switch the positions of two cars. The domain defines the actions available, such as loading a car onto the ferry or sailing the ferry to a different location, while the problem instance specifies the current state and the goals to be achieved. Classical planning methodologies have been widely used in various domains, such as logistics, robotics, and automated control systems, due to their ability to handle structured and deterministic environments. While these methods are effective in well-defined, structured environments, their reliance on exact symbolic representations makes them rigid and less adaptable to complex or dynamic scenarios.

To address these limitations, researchers have investigated the use of large language models (LLMs) in planning problems due to their ability to process and generate complex sequences of information. However, LLMs often fail to generalize well to unseen planning tasks and struggle with the systematic reasoning required to maintain coherent state transitions. For example, an LLM often fails to generate a coherent plan that correctly sequences the necessary actions. Experiments show that LLMs can have difficulty understanding how the execution of an action changes the state, and they often misinterpret the current state after a few actions have been taken. In other words, when provided with an initial state and a sequence of actions taken as input, LLMs have to infer a current state from the input, which is often misinterpreted by the LLM. This limitation becomes more pronounced as the complexity of the planning problem increases, highlighting the challenges LLMs face in this structured environment.

Furthermore, existing methods for implementing LLM-based planners employ a decoder-based generation of actions. However, using decoder-based action generation presents significant challenges in planning problems, primarily due to the requirement of sequentially generating actions rather than selecting from a predefined set. In this approach, the model must create actions one at a time, relying heavily on its understanding of the context and the current state of the world. This can lead to errors, particularly when the model misinterprets the relationships between actions and the state, resulting in illogical sequences that do not adhere to the constraints of the planning problem. For instance, in scenarios where the order of actions is critical, such as stacking blocks or navigating a ferry, the model may generate a sequence that fails to achieve the desired goal or inadvertently creates a conflict between actions. Additionally, as the complexity of the problem increases, the likelihood of the model producing valid actions diminishes, leading to inefficiencies and a reduced ability to effectively solve planning tasks compared to structured methods that utilize predefined actions.

Moreover, existing methods for implementing LLM-based planners typically use Beam search for managing the exploration of action sequences in planning problems. Unfortunately, Beam search is a local search algorithm that does not have the capability to jump between different states of the search graph. This limitation can result in the algorithm becoming trapped in local optima, as it only retains a fixed number of the most promising candidates at each iteration. Consequently, potentially optimal solutions that do not rank among the highest-scoring options initially may be excluded from consideration. Additionally, beam search lacks mechanisms for backtracking or reevaluation, making it challenging to correct errors in generated action sequences. This inflexibility often results in incomplete or flawed plans, particularly in complex domains where the interactions of actions and states necessitate a more adaptable exploration strategy.

Various embodiments of the present disclosure can be implemented to produce a solution to these problems. Embodiments described herein include systems, computer-implemented methods, and computer program products that provide a hybrid language model with an encoder model and graph search algorithm for solving planning problems, wherein the hybrid language model can be trained on simple planning problems and can generalize to complex planning problems after training. The methods and techniques described herein can introduce a high degree of accuracy and efficiency that can be advantageous in improving action selection and in achieving efficient exploration of the search space. Such improvements can allow the hybrid language model to be effectively adapted to various planning scenarios. The corresponding results provide a new and more efficient approach to implement automated planning that can be more applicable across diverse or complex domains and applications.

In various embodiments, the hybrid LM can be employed to generate a plan to solve a planning problem, wherein the hybrid LM can employ encoder-based ranking of actions and a graph search algorithm that can achieve improved prediction accuracy. For example, in various embodiments, a planning algorithm is provided, wherein the planning algorithm can comprise an input component, a conversion component, and a prediction component. In various embodiments, the input component can receive a domain and a problem instance. More specifically, the input component can receive a current state, a set of applicable actions, and a set of goal states, wherein the problem instance is defined by the current state and the set of goal states. In some cases, the current state can describe an initial state.

In various embodiments, the conversion component can update the current state for each action that is taken. That is, in various embodiments, the conversion component can covert the set of applicable actions into a set of action effects that can represent the updated current state. Therefore, as opposed to existing LLM-based planners, the hybrid language model can receive as input an updated state instead of an initial state and a sequence of actions. Such embodiments can allow the hybrid language model to focus on the current state regardless of previous actions. In other words, such embodiments can simplify the planning task for the hybrid LM by removing the need to infer the current state from the input. In various embodiments, the conversion component can encode the encodes the current state, the set of goal states, or the set of action effects into predicates. Using predicates can simplify the interaction between the world model (e.g., a representation of the environment in which an agent operates, encompassing the states, objects, relationships, and rules that govern interactions and outcomes within that environment) for the hybrid LM by providing a structured and unambiguous representation of states and actions, enabling the model to efficiently reason about relationships and make decisions based on clear logical conditions.

In various embodiments, the prediction component can generate, via the hybrid LM, a plan for the planning problem (e.g., the domain and the problem instance). To generate the plan, the hybrid LM can employ an encoder to implement encoder-based ranking of actions. On the contrary, many existing methods employ LLM models with decoder-based generation of actions. In various embodiments, the prediction component can reformulate, via the encoder, next action generation as a retrieval task. To achieve this, the prediction component can access a retrieval pool that comprises the set of applicable actions, and select an action as opposed to dynamically generating actions. Such embodiments simplify the decision-making process of the hybrid LM by narrowing down the options to those that are known to be valid within the current planning context.

Further, in various embodiments, the hybrid LM can employ a graph search algorithm as opposed to a Beam search algorithm. For example, the graph search algorithm can be a greedy best first search (GBFS) algorithm. GBFS prioritizes actions or states solely based on their heuristic values, which estimate proximity to the goal. In contrast to Beam search algorithms, this allows GBFS to jump between different stages of inference, exploring states in non-sequential order as dictated by the heuristic scores. As a result, GBFS can skip over intermediate states and focus on the most promising states, regardless of their position in the search tree, enabling efficient navigation through the search space.

These advantages are described in greater detail with reference to one or more figures.

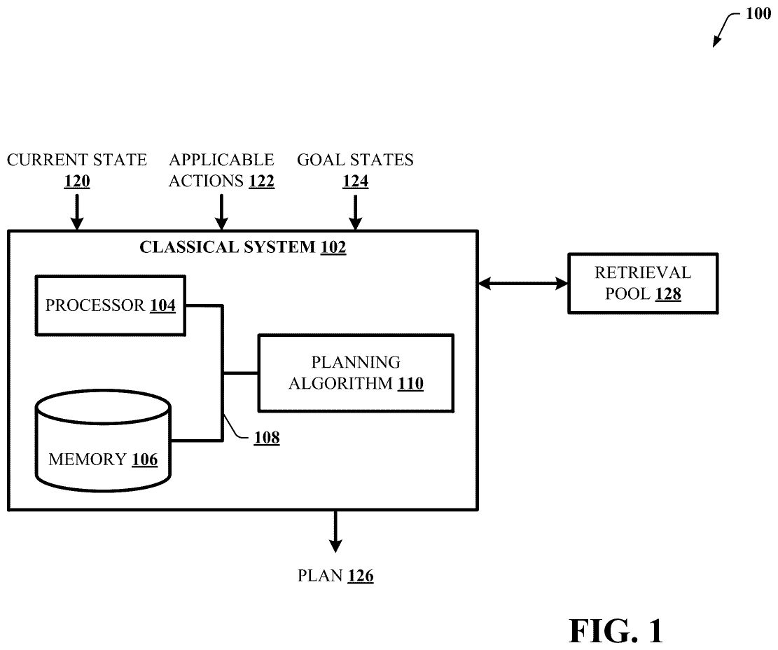

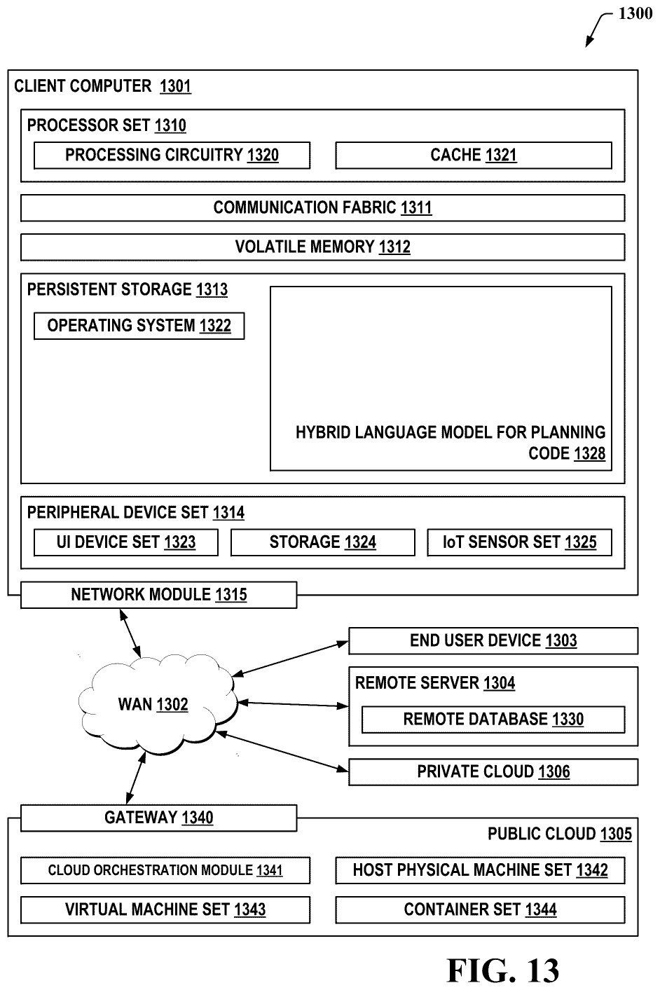

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1300 illustrated at FIG. 13. For example, non-limiting system 100 can be associated with, such as accessible via, a computing environment 1300 described below with reference to FIG. 13, such that aspects of processing can be distributed between non-limiting system 100 and the computing environment 1300. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can facilitate planning via a hybrid language model with encoder models and graph search algorithms in accordance with one or more embodiments described herein.

Non-limiting system 100 and/or the components of non-limiting system 100 can be employed to use hardware and/or software to solve problems that are highly technical in nature (e.g., related to planning problems, LLM-based planners, encoder models etc.), that are not abstract and that cannot be performed as a set of mental acts by a human. Further, some of the processes performed may be performed by specialized computers for carrying out defined tasks related to a hybrid language model for planning via encoder models and graph search algorithms. Non-limiting system 100 and/or components of non-limiting system 100 can be employed to solve new problems that arise through advancements in technologies mentioned above, computer architecture, and/or the like. Non-limiting system 100 can provide technical improvements to computing systems for planning by improving the computational efficiency involved in generating plans, reducing inference time, providing improved generalization to complex planning problems when trained on simple planning problems, etc.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., planning algorithm 110, input component 202, conversion component 204, and/or prediction component 206) to perform one or more actions. In one or more embodiments, memory 106 can store computer-executable components (e.g., planning algorithm 110, input component 202, conversion component 204, and/or prediction component 206).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

As illustrated in FIG. 1, non-limiting system 100 can comprise classical system 102. Classical system 102 can comprise one or more components, such as a memory 106, processor 104, bus 108, and/or planning algorithm 110.

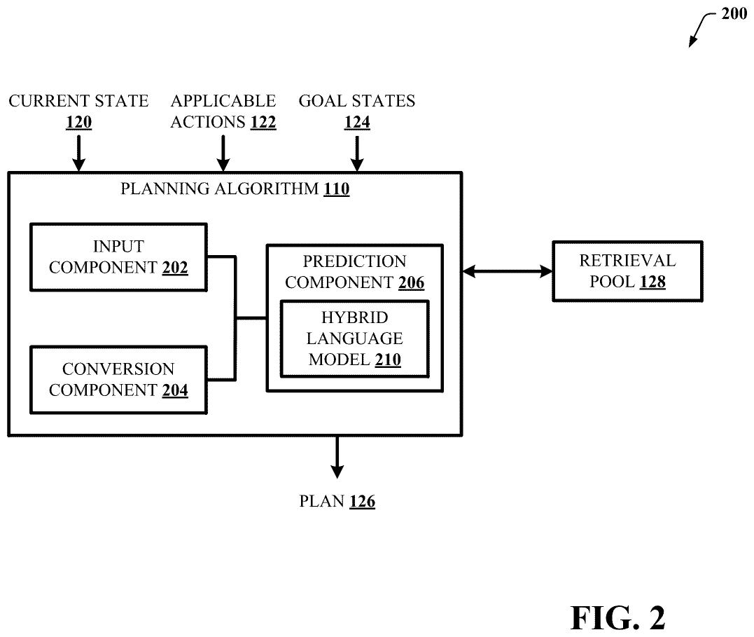

In various embodiments, planning algorithm 110 can comprise input component 202, conversion component 204, and prediction component 206 as illustrated in FIG. 2. In various embodiments, prediction component 206 can comprise a hybrid LM 210. In various embodiments, as described herein, the hybrid LM 210 can employ an encoder model and a graph search algorithm.

In various embodiments, input component 202 can receive a domain and a particular problem instance in the domain. That is, the input component 202 can receive a current state 120, a set of applicable actions 122, and a set of goal states 124 that define the domain particular problem instance in the domain.

In various aspects, the input component 202 can be retrieved from a retrieval pool 128. In various embodiments, the retrieval pool 128 can comprise applicable actions, and the input component 202 can electronically access the retrieval pool 128 to obtain the set of applicable actions 122. In some cases, the retrieval pool 128 can be a stored collection or database of the set of applicable actions 122. The retrieval pool 128 can be advantageous in allowing the hybrid LM 210 to generate plan 126 without inferring or predicting the current state 120. That is, the hybrid LM 210 can operate within an environment (e.g., world system) that already provides the updated state as it can be provided by the environment from the retrieval pool 128.

In various cases, the problem instance that defines the planning problem can be represented by a unification (e.g., a concatenation) of the current state 120 and a set of goal states 124. This can also be referred to as the query that is input into hybrid LM 210. In various cases, the context to the query can be represented by the set of applicable actions 122.

FIG. 2 illustrates a block diagram of an example, non-limiting system 200 that can facilitate planning via a hybrid language model with encoder models and graph search algorithms in accordance with one or more embodiments described herein. Repetitive description of like elements and/or processes employed in respective embodiments is omitted for sake of brevity.

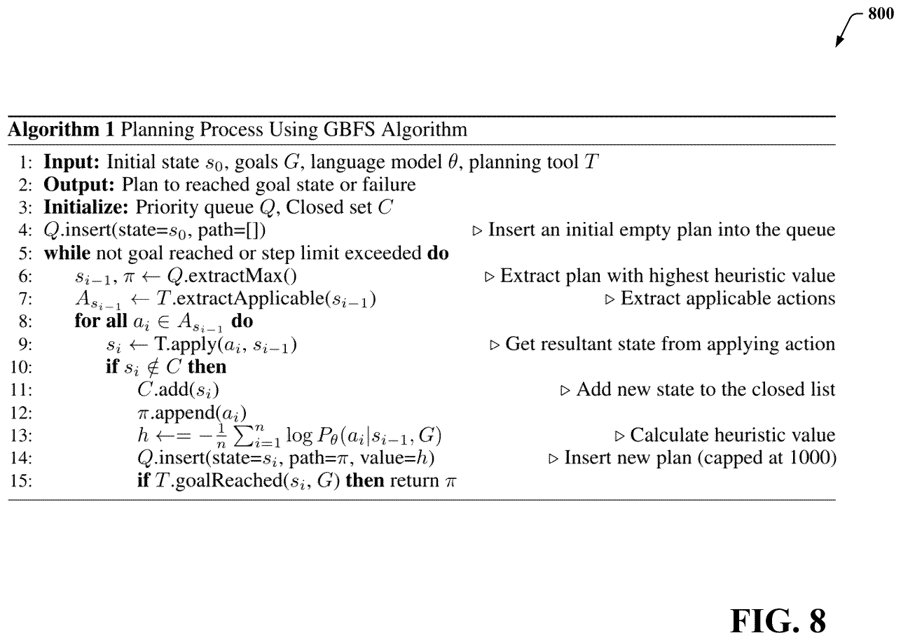

As described with reference to FIG. 1, planning algorithm 110 can comprise input component 202, conversion component 204, and prediction component 206. In this regard, non-limiting system 200 describes the system of planning algorithm 110 (i.e., Algorithm 1 presented in FIG. 8) that can employ hybrid LM 210 with an encoder (e.g., encoder model) and a graph search algorithm to generate the plan 126 for a planning problem.

Embodiments described herein provide a hybrid LM that can accurately and efficiently generalize to complex problem instances in some cases. For example, in various embodiments, planning algorithm 110 can comprise encoder-based action ranking of the set of applicable actions 122. For example, planning algorithm 110 can comprise an encoder. Encoder-based action ranking can comprise determining respective scores of the set of applicable actions 122 to rank the set of applicable actions, and inserting the set of applicable actions 122 with the respective scores into a prioritized queue. Upon generation, via the encoder, of encoded representations of the current state 120, the set of applicable actions 122, and the set of goal states 124, similarity values between the encoded representations can be determined and totaled to generate the respective scores of the set of applicable actions 122. Thereafter, planning algorithm 110 can employ a graph search algorithm such as greedy best first search (GBFS). For instance, in various embodiments, the prediction component 206 can, via hybrid LM 210, extract a set of plans (e.g., subplans) based on a heuristic value from the prioritized queue. This process is performed in each iteration until the set of goal states 124 is achieved. Planning algorithm 110 can determine the respective scores via the encoder of the hybrid LM 210.

In various embodiments, the prediction component 206 can electronically store, maintain, control, or otherwise access the hybrid LM 210 that can be configured to generate plans based on an input planning problem. In addition to the encoder (e.g., encoder-based action ranking architecture) an implementation of the graph search algorithm, the hybrid LM 210 can exhibit any suitable artificial intelligence architecture (e.g., a deep learning neural network architecture) and can be trained in any suitable fashion, as described herein with respect to FIG.

More specifically, an input layer of the hybrid LM 210 can receive the current state 120, the set of goal states 124, and the set of applicable actions 122. The current state 120, the set of goal states 124, or the set of applicable actions 122 can complete a forward pass through one or more hidden layers of the hybrid LM 210, and an output layer of the hybrid LM 210 can generate the plan 126 based in activations provided by the one or more hidden layers. In various aspects, the plan 126 can have any suitable format, size, or dimensionality.

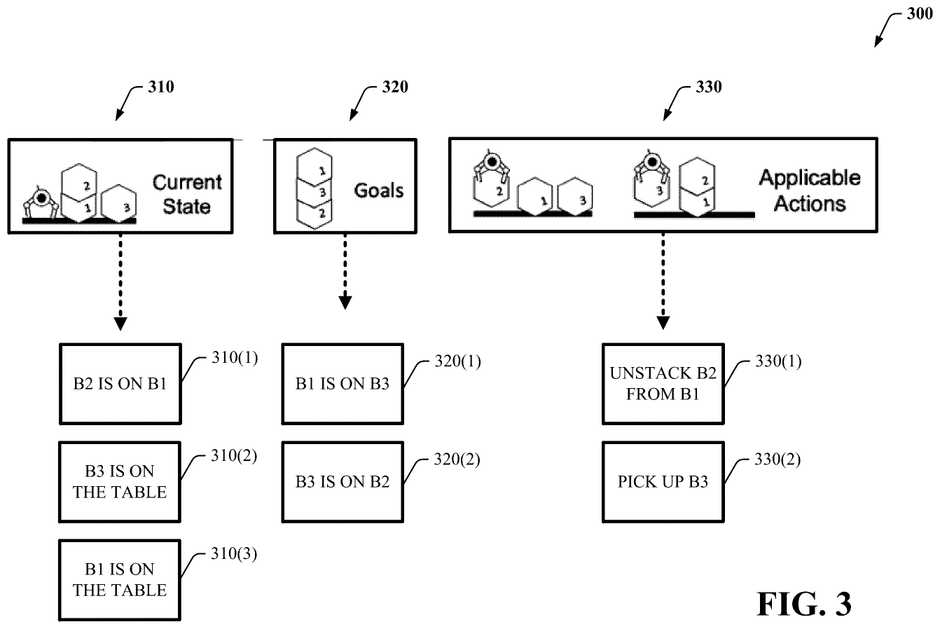

FIG. 3 illustrates diagrams of example, non-limiting problem domain and problem instance 300 in accordance with one or more embodiments described herein. Repetitive description of like elements and/or processes employed in respective embodiments is omitted for sake of brevity.

In various aspects, non-limiting problem domain and problem instance 300, as referenced to herein, illustrates an example planning problem. For instance, the problem domain can be the blocks domain. In the blocks domain, the blocks domain is a classical planning problem where the objective is to stack and unstack blocks on a table to achieve a specified goal configuration, involving actions like picking up, putting down, and stacking blocks in a defined order. As a non-limiting example, the problem instance can involve a block 1, a block 2, and a block 3, and can be defined by a current state 310, a set of goal states 320, and a set of applicable actions 330. In various cases, the current state can comprise a state 310(1), a state 310(2), and a state 310(3), wherein the states are “b2 is on b1”, “b3 is on the table”, and “b1 is on the table” respectively. As used herein, “b1”, “b2”, and “b3” can refer to block 1, block 2, and block 3 respectively. In the non-limiting example, the set of goal states 320 can comprise a state 320(1) and a state 320(2), wherein the states are “b1 is on b3” and “b3 is on b2” respectively. Further in the non-limiting example, the set of applicable actions 330 can comprise an action 330(1) and an action 330(2), wherein the actions are “unstack b2 from b1” and “pick up b2” respectively.

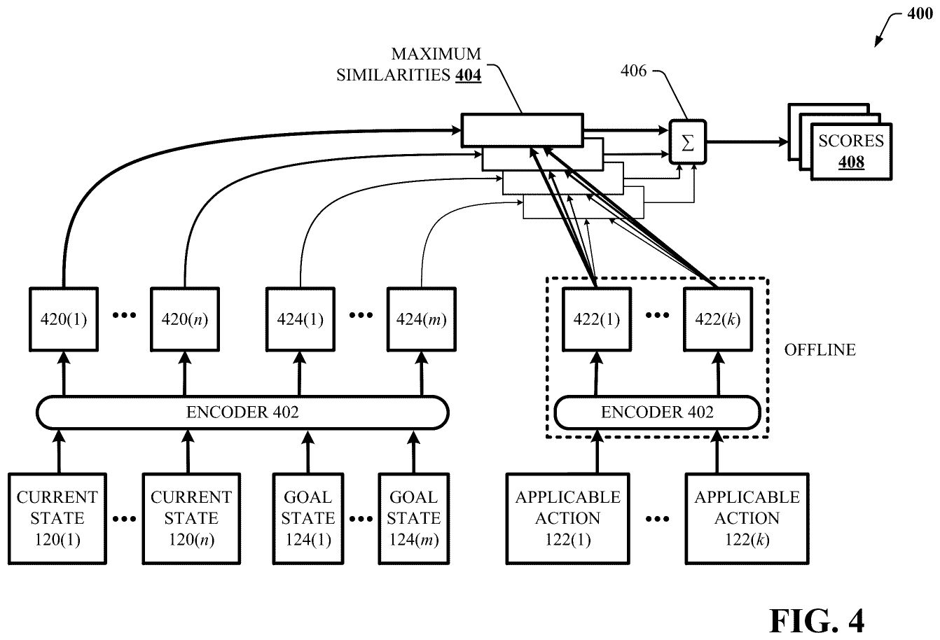

FIG. 4 illustrates a diagram of example, non-limiting encoder-based action ranking 400 of the hybrid language model in accordance with one or more embodiments described herein. Repetitive description of like elements and/or processes employed in respective embodiments is omitted for sake of brevity.

With continued reference to the embodiments of FIGS. 1 and 2, the current state 120 can comprise any suitable number of tokens. That is, the current state 120 can comprise any suitable positive integer n of tokens: a token 120(1) to a token 120(n). Similarly, the set of goal states 124 can comprise any suitable positive integer m of tokens: a token 124(1) to a token 124(m). Additionally, the set of applicable actions 122 can comprise any suitable positive integer k of tokens: a token 122(1) to a token 122(k). For example, referencing the non-limiting domain and problem instance 300 in FIG. 3, the current state 120 can comprise the following tokens: “b2 is on b1”, “b3 is on the table”, and “b1 is on the table”. Further referencing FIG. 3, the set of goal states 124 can comprise the following tokens: “b1 is on b3” and “b3 is on b2”.

In various aspects, the conversion component 204 can prepend each token with a special token based on its type. For instance, the special tokens can comprises the following tokens: “INITIAL”, “GOAL”, “POSITIVE EFFECT”, or “NEGATIVE EFFECT”. Such special tokens can describe the initial state (e.g., the current state 120), the set of goal states 124, and the set of applicable actions 122, along with their effects, for inputting the tokens into the hybrid LM 210.

In various embodiments, the hybrid LM 210 can comprise an encoder-based action ranking architecture. That is, hybrid LM 210 can comprise an encoder 402. In various instances, the encoder 402 can generate encoded representations 422 of the set of applicable actions 122. Similarly, the encoder 402 can generate encoded representations 420 of the current state 120 and encoded representations 424 of the set of goal states 124. Accordingly, there can be n encoded representations 420: an encoding 420(1) to an encoding 420(n). There can also be m encoded representations 424: an encoding 424(1) to an encoding 424(m). Further, there can be k encoded representations 422: an encoding 422(1) to an encoding 422(k).

In various aspects, the encoded representations (e.g., 420, 422, 424) can be high dimensional vectors that represent meanings and relationships in the tokens (e.g., represent meanings and relationships of the blocks to comprehend the overall arrangement and interactions between the blocks in the block domain). Moreover, each respective encoded representation of each token can consist of any suitable number of vectors to describe or capture the meanings and relationships in each token.

In various embodiments, the encoder 402 can be a bi-encoder. A bi-encoder model consists of two separate encoders that process two different inputs independently, usually for tasks involving similarity or retrieval. In a bi-encoder model, each encoder generates encoded representations for its respective input, and these encoded representations are compared (e.g., using techniques like cosine similarity) to determine relationships or relevance between the two inputs. In the non-limiting encoder-based action ranking 400, the encoder 402 can implement such functionality. That is, the encoder 402 can encode the set of applicable actions 122 separately and independently from the current state 120 and the set of goal states 124. Thus, the prediction component 206 can generate the encoded representations 422 offline. This can be achieved due to the fact that the set of applicable actions 122 are not dependent on the current state 120. Generating the encoded representations 422 offline can involve precomputing and storing the encoded representations 422 of the set of applicable actions 122 in advance, rather than generating them dynamically during each iteration of the planning process. Such aspects can increase computational efficiency of the hybrid LM 210 by allowing the encoded representations 422 to be generated once and stored for subsequent use during inferencing. This can specifically reduce inferencing time by not generating the encoded representations 422 dynamically.

Thereafter, in various embodiments, non-limiting encoder-based action ranking 400 can determine, using a similarity function, scores 408 of the set of applicable actions 122 respectively. In particular, the prediction component 206 can implement ColBERT late-interaction to generate the scores 408 using the encoded representations of the current state 120, the set of goal states 124, and the set of applicable actions 122. ColBERT's late-interaction mechanism computes token-level similarities between query embeddings (e.g., the encoded representations 420 and the encoded representations 422) and action embeddings (e.g., the encoded representations 422) after encoding, allowing for fine-grained matching without exhaustive full-sequence comparisons.

Specifically, prediction component 206 can compute, using the similarity function, a maximum similarity 404 (e.g., a maximum cosine similarity) between individual tokens of the current state 120 and the set of goal states 124 and individual tokens of the set of applicable actions 122. Thereafter, prediction component 206 can compute a total similarity score for an action by summing (e.g., represented by summation operator 406) the maximum similarity 404 for each token in the current state 120 and the set of goal states 124. The total similarity score for each action of the set of applicable actions 122 can make up the scores 408. By implementing such late interaction scheme, encoder-based action ranking can not only improve computational efficiency, particularly when evaluating larger quantities of the set of applicable actions 122 but can also enhance prediction accuracy.

The architecture of non-limiting encoder-based action ranking 400 can be advantageous in reducing the size of LLM-based planners for generating plans for planning problems. This is due to the fact that the hybrid LM 210 only uses an encoder as opposed to encoder-decoder architectures of typical LLM-based planners. Thus, the hybrid LM 210 can comprise a reduced size when deployed, improving resource costs and increasing efficiency in employing hybrid LM 210 for planning. Accordingly, the hybrid LM can be considered a language model instead of a large language model.

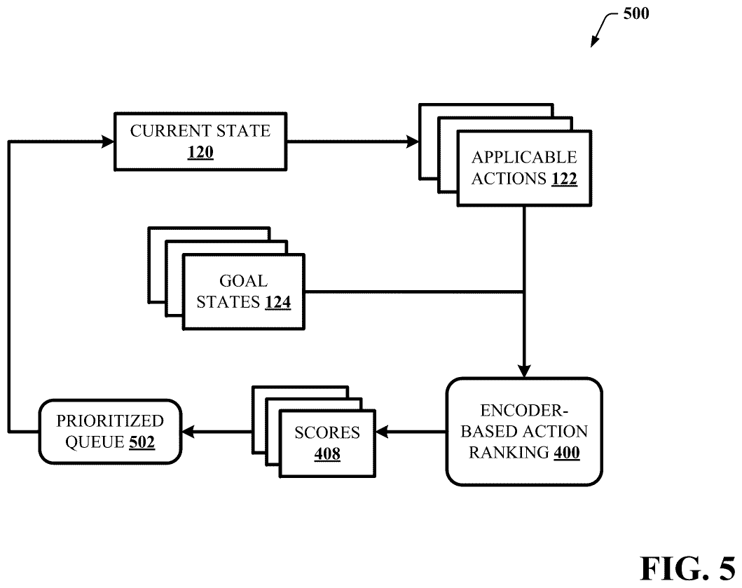

FIG. 5 illustrates a diagram of example, non-limiting graph search algorithm 500 used by the hybrid language model in accordance with one or more embodiments described herein. Repetitive description of like elements and/or processes employed in respective embodiments is omitted for sake of brevity.

In various embodiments, the prediction component 206 can employ, with the hybrid LM 210, non-limiting graph search algorithm 500 as opposed to local search methods typically used in LLM-base planners. For instance, the non-limiting graph search algorithm 500 can be GBFS. As depicted in non-limiting graph search algorithm 500, the non-limiting encoder-based action ranking 400 can output the scores 408. Thereafter, prediction component 206 can insert the scores 408 with the respective action from the set of applicable actions 122 into a prioritized queue 502. This process can be performed iteratively for each action from the set of applicable actions 122.

In various aspects, GBFS prioritizes paths (e.g., plans, subplans) based on a heuristic value that focuses exploration on the most promising options. Unlike beam search in existing methods, GBFS offers greater flexibility by allowing initial paths to be abandoned in favor of more promising alternatives. In various embodiments, GBFS can involve prediction component 206 determining a heuristic value. In various aspects, the heuristic value can be determined by applying the following cost function:

$$Cost ( π ) = - \frac{1}{n} {\sum }_{i = 1}^{n} log {P}_{θ} ( {a}_{i} \vert {s}_{i - 1} , G )$$

In the cost function, π denotes the number of actions in plan 126, P_{θ}(aᵢ|sᵢ₋₁,G) denotes the probability of choosing an action aᵢ given the current state sᵢ₋₁, and G denotes the set of goal states 124. In various embodiments, GBFS can reduce inherent bias with this formulation due to averaging of the probabilities to equitably account for each action's impact, thereby preventing longer paths from being unfairly penalized. As demonstrated in Algorithm 1 depicted in FIG. 8, during each iteration, prediction component 206 extracts, via the hybrid LM 210, a partial plan (e.g., a subplan) with a maximum heuristic value from the prioritized queue 502. The partial plans extracted from the prioritized queue 502 can be considered as a set of plans. Accordingly, prediction component 206 can determine the current state 120 that results from each applicable action in the plan's most previous state. Thereafter, the prediction component 206 can apply the cost function to evaluate the plan, and reinsert the plan into the prioritized queue 502 for subsequent consideration. Such a process is iterated until the set of goal states 124 are achieved or a search limit (e.g., step limit) is achieved. In other words, after a plan is extracted based on the maximum heuristic value, the current state 120 is updated, and the scores 408 of the set of applicable actions 122 (e.g., receive from retrieval pool 128) are recalculated. Accordingly, the recalculated scores 408 and respective actions from the set of applicable actions 122 are inserted into the prioritized queue 502. This process is iterated until the current state 120 is equivalent to the set of goal states 124 or until a search limit has been reached.

In various aspects, prediction component 206 can calculate, via the hybrid LM 210, the probability P (aᵢ|sᵢ₋₁,G) that a given action a; in the state sᵢ₋₁ is a correct action to take towards achieving the goal G (e.g., achieving the set of goal states 124). In various aspects, each of the scores 408 can be defined by this probability.

The planning procedure employed by planning algorithm 110 to generate plan 126 via the hybrid LM 210 with GBFS can be elaborated as follows. This planning procedure with GBFS is also summarized by Algorithm 1 presented in FIG. 8.

In various aspects, the planning algorithm 110 with GBFS can comprise receiving an initial state so and goals G. For instance, input component 202 can input the initial state and goals into the hybrid LM 210. As a result, the planning algorithm 110 with GBFS can output the plan 126 that solves the planning problem or a failure indicator. In various aspects, the prediction component 206 can initialize the prioritized queue 502 (e.g., priority queue) and insert an initial empty plan. In various aspects, as previously described, until the goals G or the search limit is reached, the prediction component 206 can iteratively extract plans with a maximum heuristic value and its set of applicable actions 122 to update the current state 120. After updating the current state 120, the heuristic value of the extracted plan can be calculated, and the plan can be inserted into the prioritized queue 502.

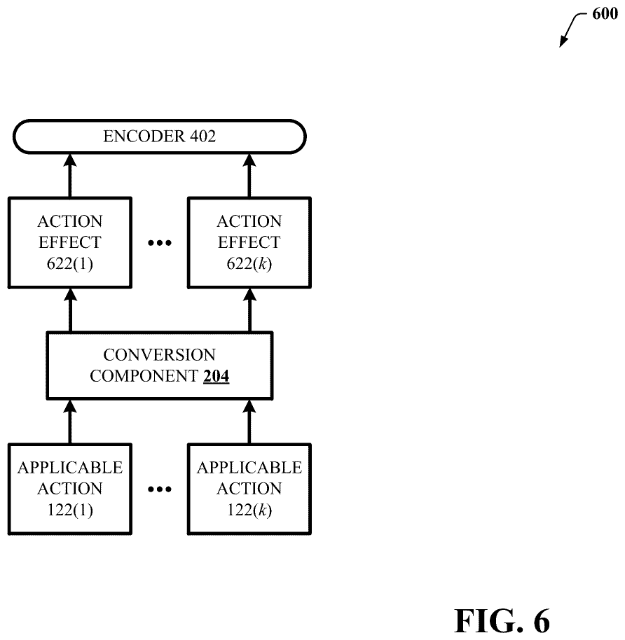

FIG. 6 illustrates an example, non-limiting block diagram 600 showing conversion of applicable actions into action effects in accordance with one or more embodiments described herein. Repetitive description of like elements and/or processes employed in respective embodiments is omitted for sake of brevity.

As discussed with reference to at least FIG. 5, conversion component 204 can convert the set of applicable actions 122 into a set of action effects 622. Accordingly, the set of action effects 622 can comprise k action effects: an action effect 622(1) to an action effect 622(k). In other words, the set of applicable actions 122 and the set of action effects 622 can comprise the same number of elements. In one or more embodiments, the prediction component 206 can access the set of action effects 622 and input the set of action effects 622 into the hybrid LM 210. Thus, the encoder 402 can generate the encoded representations 422 from the set of action effects 622.

In various instances, conversion component 204 can encode the current state 120, the set of goal states 124, or the set of action effects into predicates. A predicate is a logical statement or function that expresses a property or relation about one or more subjects, typically used to define conditions or states within a formal system. Typically, the current state 120 or the set of goal states 124 are represented as predicates. On the other hand, actions are not represented as predicates. For instance, actions are often represented as functions or operators that take the current state as input and produce a new state. Accordingly, in any case, the conversion component 204 can convert the current state 120, the set of goal states 124, or the set of action effects into predicates, further enabling the hybrid LM 210 to refrain from having to infer a current state of the world system. By converting the set of applicable actions 122, the set of action effects 622 can now be represented as predicates that describe the outcome or state change resulting from the action.

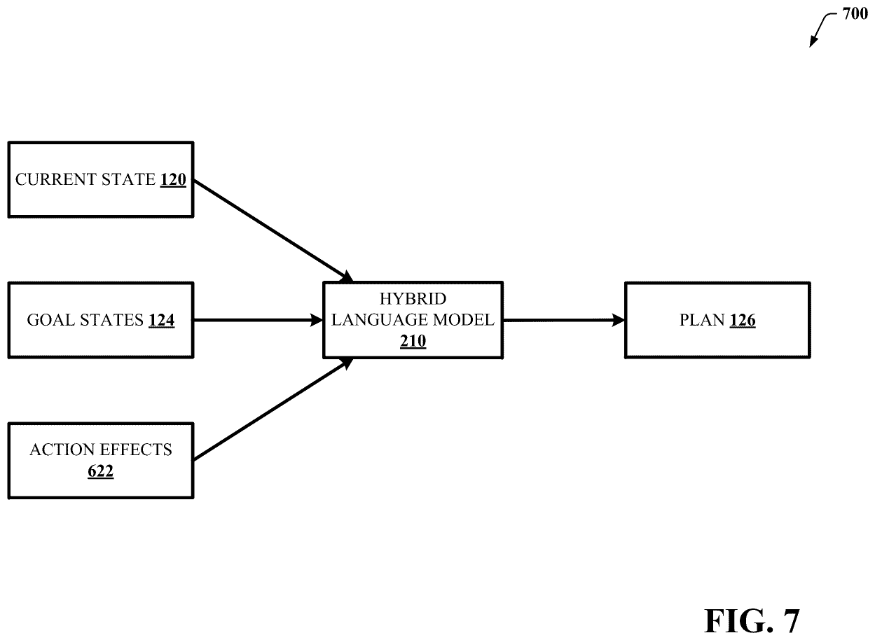

FIG. 7 illustrates an example, non-limiting block diagram 700 showing generation of a plan for a planning problem in accordance with one or more embodiments described herein. Repetitive description of like elements and/or processes employed in respective embodiments is omitted for sake of brevity.

With reference to at least FIGS. 1-6, in one or more embodiments, the prediction component 206 can input the current state 120, the set of goal states 124, and the set of action effects 622 into hybrid LM 210. As a result, the hybrid LM 210 can output the plan 126 that corresponds to the planning problem defined by current state 120 and the set of goal states 124. That is, the hybrid LM 210 can output the plan 126 that solves the planning problem. In some instances, if the search limit is reached before the set of goal states 124 are reached, the hybrid LM 210 can output an error or failure indicator.

In various aspects, the hybrid LM 210 can receive the current state 120, the set of goal states 124, and the set of action effects 622 as tokens. As previously described herein, conversion component 204 can prepend the tokens with respective special tokens that identify the type of token.

In various embodiments, the conversion component 204 can linearize the set of applicable actions 122. Particularly, the conversion component 204 can linearize the predicates of the set of action effects 622. Furthermore, the conversion component 204 can linearize the problem instance. More specifically, the conversion component 204 can linearize the current state 120 and the set of goal states 124. In various instances, the conversion component 204 can linearize the problem instance by shuffling the current state 120 with the set of goal states 124. Thereafter, conversion component 204 can convert the current state 120, the set of goal states 124, and the set of action effects 622 into the tokens. That is, conversion component 204 can convert the predicates of the current state 120, the set of goal states 124, and the set of action effects 622 into the tokens to be used as input for the hybrid LM 210 to prevent the hybrid LM 210 from having to infer a current state of the world system.

In various embodiments, the prediction component 206 can facilitate training of the hybrid LM 210. In various aspects, the prediction component 206 can utilize any suitable training methods to train the hybrid LM 210. For example, the prediction component 206 can employ a contrastive learning approach to train the hybrid LM 210. Implementing a contrastive learning approach can be advantageous in allowing the hybrid LM 210 to learn from both correct (ground-truth) and incorrect (predicted) actions. This enhances the ability of hybrid LM 210 to differentiate between effective and ineffective actions, ultimately improving its performance.

In various embodiments, prediction component 206 can facilitate contrastive learning for training the hybrid LM 210 by selecting an action from the set of applicable actions 122 with a maximum score from the scores 408. Referencing the non-limiting encoder-based action ranking 400 in FIG. 4, the scores 408 are based on a subset of query tokens that represent the problem instance. The query tokens are the tokens in the unified representation of the current state 120 and the set of goal states 124. In other words, the conversion component 204 can unify the current state 120 and the set of goal states 124 (or its predicates) to form the query that is input into hybrid LM 210. In various aspects, such unification can represent the problem instance. In any instance, prediction component 206 can compare the action with the maximum score with a ground-truth action. In various embodiments, prediction component 206 can facilitate such comparing using any suitable contrastive loss function, and thus reinforce correct action selections while penalizing incorrect ones.

FIG. 8 illustrates a diagram of example, non-limiting planning algorithm 800 via a hybrid language model in accordance with one or more embodiments described herein. Repetitive description of like elements and/or processes employed in respective embodiments is omitted for sake of brevity.

Non-limiting planning algorithm 800 is a formal representation of the planning procedure described in various embodiments herein to generate a plan, such as plan 126, for a planning problem. As such, non-limiting planning algorithm 800 can be analogous to planning algorithm 110.

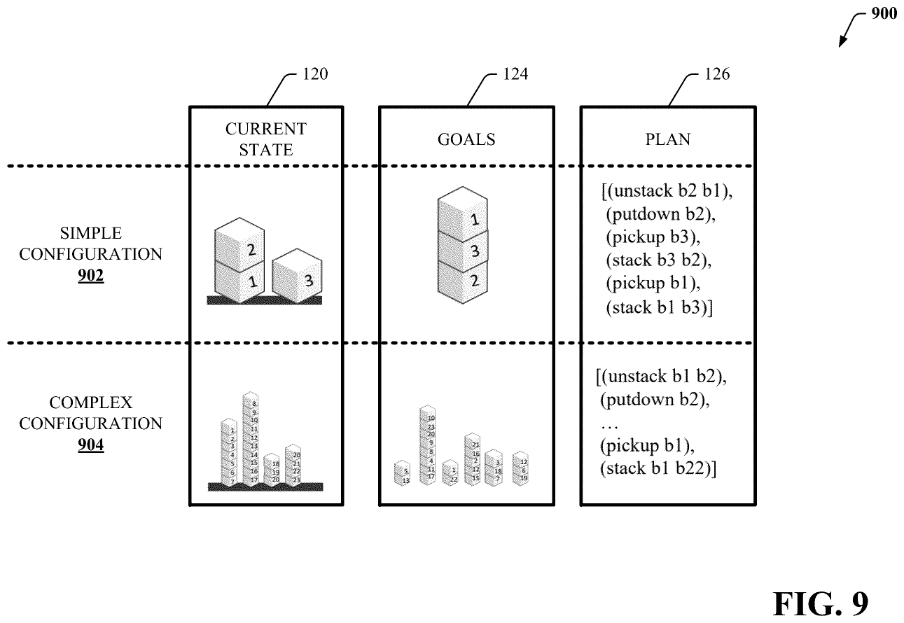

FIG. 9 illustrates a diagram of example, non-limiting experiment setup 900 of the hybrid language model and existing methods in accordance with one or more embodiments described herein.

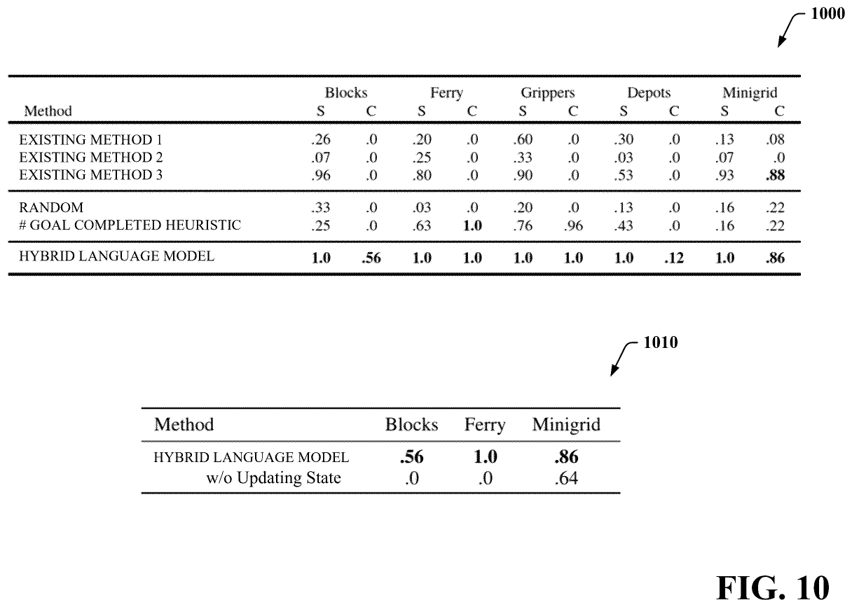

With reference to FIGS. 9 and 10, the non-limiting experiment setup 900 for testing the planning algorithm with the hybrid LM 210 and 4 existing methods comprises training on a simple configuration 902. The simple configuration 902 is a simplified problem instance of a domain. For instance, in the block domain, the problem instance can involve only 3 blocks and be defined by the current state 120 and the set of goal states 124 as shown, with a correct plan 126. Specifically, in the simple configuration 902 in the block domain, the current state 120 can be defined by “block 2 is on block 1”, “block 1 is on the table”, and “block 3 is on the table”. In the complex configuration, there can be a plurality of blocks involved, such as 25 blocks, which significantly increases the length of the correct plan 126. For testing, the planning algorithm with the hybrid LM 210 and the 4 existing methods are applied to the complex configuration 904.

FIG. 10 illustrates diagrams of example, non-limiting experiment results 1000 and 1010 of the hybrid language model and existing methods in accordance with one or more embodiments described herein.

Referring to non-limiting experiment results 1000, the planning algorithm with the hybrid LM 210 and 4 existing methods were tested over 5 different domains, wherein training was performed on the simple configuration 902 and testing was performed on the complex configuration 904. Experimental results corresponding to the planning algorithm with the hybrid LM 210 exhibit a significant improvement over existing methods. As shown, the existing methods generally do not succeed in generalizing to the complex configuration 904 if only trained on simple configuration 902, mostly exhibiting 0.0 success rates. It has been demonstrated that the planning algorithm with the hybrid LM 210 can lead to a better performance than existing methods, exhibiting perfect success rates (e.g., 1.0 success rate) over most domains in the simple configuration 902 and the complex configuration 904. Thus, the planning algorithm with the hybrid LM 210 demonstrates significant improvement in generalization than existing methods.

Now referencing non-limiting experiment results 1010, the planning algorithm with the hybrid LM 210 was tested without state updates. As shown, eliminating state updates led to poor performance, highlighting the difficulty for language models to manage world modeling. Therefore, it can be concluded that providing updated states to the hybrid LM 210 as opposed to existing methods of inputting an initial state with a sequence of actions (e.g., providing action effects instead of the actions themselves as input) results in a significant improvement in prediction accuracy and understanding of the world model.

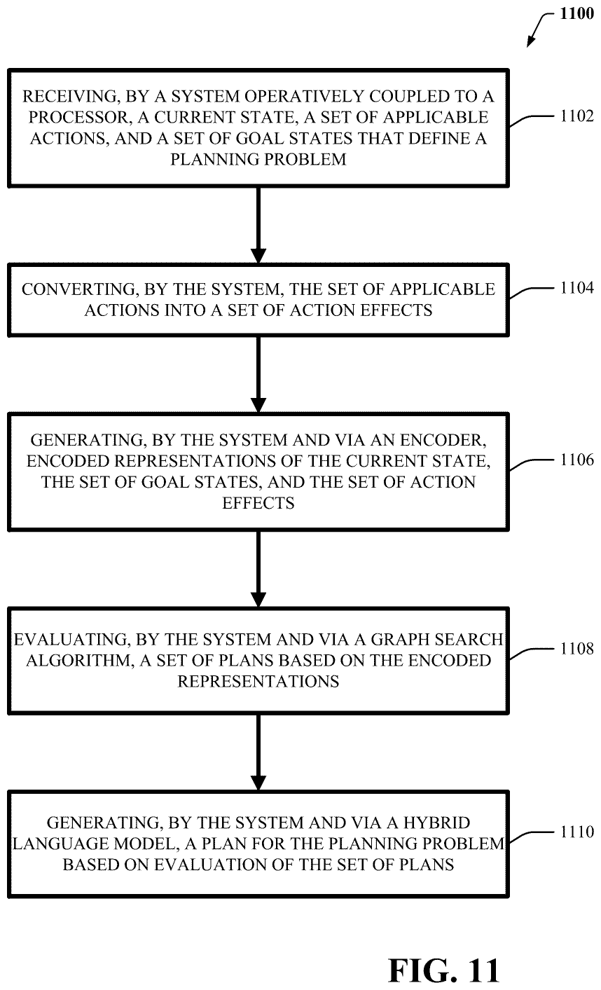

FIG. 11 illustrates a flow diagram of an example, non-limiting method 1100 that can facilitate planning via a hybrid language model with encoder models and graph search algorithms in accordance with one or more embodiments described herein. Repetitive description of like elements and/or processes employed in respective embodiments is omitted for sake of brevity.
At 1102, non-limiting method 1100 can comprise receiving (e.g., by input component 2043), by a system operatively coupled to a processor, a current state, a set of applicable actions, and a set of goal states that define a planning problem.
At 1104, non-limiting method 1100 can comprise converting (e.g., by prediction component 206), by the system, the set of applicable actions into a set of action effects.
At 1106, non-limiting method 1100 can comprise searching (e.g., by prediction component 206), by the system and via an encoder, encoded representations of the current state, the set of goal states, and the set of action effects.
At 1108, non-limiting method 1100 can comprise evaluating, by the system and via a graph search algorithm, a set of plans based on the encoded representations.
At 1110, non-limiting method 1100 can comprise generating, by the system and via a hybrid language model, a plan for the planning problem based on evaluation of the set of plans.

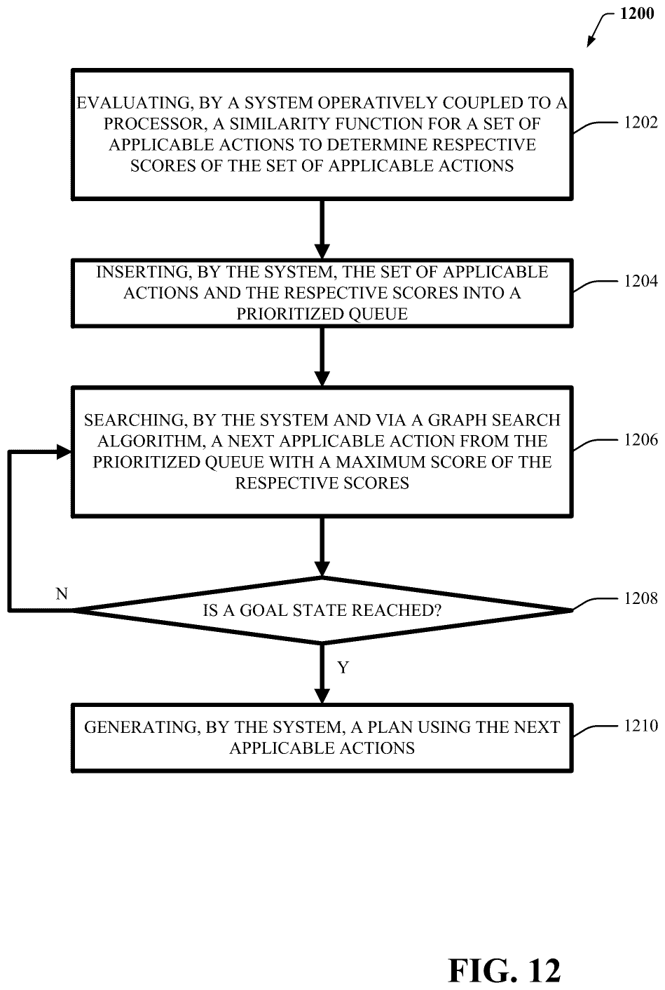

FIG. 12 illustrates a flow diagram of an example, non-limiting method 1200 that can facilitate planning via a hybrid language model with encoder models and graph search algorithms in accordance with one or more embodiments described herein. Repetitive description of like elements and/or processes employed in respective embodiments is omitted for sake of brevity.
At 1202, non-limiting method 1200 can comprise evaluating (e.g., by prediction component 206), by a system operatively coupled to a processor, a similarity function for a set of applicable actions to determine respective scores of the set of applicable actions.
At 1204, non-limiting method 1200 can comprise inserting (e.g., by prediction component 206), by the system, the set of applicable actions and the respective scores into a prioritized queue.
At 1206, non-limiting method 1200 can comprise searching (e.g., by prediction component 206), by the system and via a graph search algorithm, a next applicable action from the prioritized queue with a maximum score of the respective scores.
At 1208, non-limiting method 1200 can comprise determining (e.g., by prediction component 206), by the system, if a goal state has been reached. If yes, then at 1210, non-limiting method 1200 can comprise generating (e.g., by prediction component 206), a plan using the next applicable actions. If not, non-limiting method 1200 can proceed to 1206.

In various embodiments, although not shown, non-limiting method 1200 can further comprise determining if a defined search limit has been reached. If so, non-limiting method 1200 can terminate. If not, non-limiting method 1200 can proceed to 1206.

FIG. 13 illustrates a block diagram of an example, non-limiting, operating environment 1300 in which one or more embodiments described herein can be facilitated. FIG. 13 and the following discussion are intended to provide a general description of a suitable operating environment 1300 in which one or more embodiments described herein at FIGS. 1-12 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as hybrid language model for planning code 1328. In addition to block 1328, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1328, as identified above), peripheral device set 1314 (including user interface (UI) device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer-readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1328 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, volatile memory 1312 is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface-type operating systems that employ a kernel. The code included in block 1328 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer-readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN 1302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

CLOUD COMPUTING SERVICES AND/OR MICROSERVICES (not separately shown in FIG. 13): private and public clouds 1306 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes at least one of the computer executable components that:
receives a current state, a set of applicable actions, and a set of goal states that define a planning problem; and
generates, via a language model, a plan for the planning problem, wherein generating the plan for the planning problem comprises:
generating, via an encoder, respective encoded representations of the current state, the set of applicable actions; and
evaluating, via a graph search algorithm, a set of plans based on the encoded representations.

2. The system of claim 1, wherein the encoder is a bi-decoder that generates the respective encoded representations of the set of applicable actions separate from the respective encoded representations of the current state and the set of goal states.

3. The system of claim 1, wherein the encoder generates the respective encoded representations of the set of applicable actions in an offline process and stores the respective encoded representations of the set of applicable actions for subsequent use.

4. The system of claim 1, wherein the at least one of the computer executable components further:
determines, using a similarity function, respective scores the set of applicable actions based on a similarity to the current state or the set of goal states.

5. The system of claim 4, wherein the at least one of the computer executable components further:
inserts the set of applicable actions with the respective scores into a prioritized queue; and
selects a next applicable action based on a maximum score of the respective scores.

6. The system of claim 5, wherein the at least one of the computer executable components further:
determines respective heuristic values of the set of plans based on the respective scores of the set of applicable actions to evaluate the set of plans for determining the next applicable action; and
applies a cost function to determine the respective heuristic values of the set of plans.

7. The system of claim 1, wherein the at least one of the computer executable components further:
converts the set of applicable actions into a set of action effects;
encodes the current state, the set of goal states, or the set of action effects into predicates; and
generates, via the encoder, the respective encoded representations from the predicates.

8. The system of claim 6, wherein the graph search algorithm selects states for exploration from the prioritized queue based on the respective heuristic values of the set of plans.

9. The system of claim 7, wherein the at least one of the computer executable components further:
unifies the predicates of the current state and the predicates of the set of goal states to represent a problem instance of the planning problem.

10. The system of claim 9, wherein the at least one of the computer executable components further:
linearizes the predicates of the set of action effects;
linearizes the problem instance, wherein linearizing the problem instance comprises:
shuffling the predicates of the current state with the predicates of the set of goal states; and
converting the predicates into tokens.

11. The system of claim 1, wherein the at least one of the computer executable components further:
selects an action from a retrieval pool that comprises the set of applicable actions.

12. The system of claim 9, wherein the at least one of the computer executable components further:
selects an action with a maximum score from the respective scores of the set of applicable actions based on a subset of query tokens representing the problem instance; and
compares the action with a ground-truth action using a contrastive loss function to train the language model.

13. A computer-implemented method, comprising:
receiving, by a system operatively coupled to a processor, a current state, a set of applicable actions, and a set of goal states that define a planning problem;
generating, by the system and via a language model, a plan for the planning problem, wherein generating the plan for the planning problem comprises;
generating, via an encoder, respective encoded representations of the current state, the set of applicable actions; and
evaluating, via a graph search algorithm, a set of plans based on the encoded representations.

14. The computer-implemented method of claim 13, wherein the encoder is a bi-decoder that generates the respective encoded representations of the set of applicable actions separate from the respective encoded representations of the current state and the set of goal states.

15. The computer-implemented method of claim 13, further comprising:
determining, by the system, using a similarity function, respective scores the set of applicable actions based on a similarity to the current state or the set of goal states.

16. The computer-implemented method of claim 15, further comprising:
inserting, by the system, the set of applicable actions with the respective scores into a prioritized queue; and
selecting, by the system, a next applicable action based on a maximum score of the respective scores.

17. The computer-implemented method of claim 13, further comprising:
converts the set of applicable actions into a set of action effects;
encodes the current state, the set of goal states, or the set of action effects into predicates; and
generates, via the encoder, the respective encoded representations from the predicates.

18. The computer-implemented method of claim 17, further comprising:
unifies the predicates of the current state and the predicates of the set of goal states to represent a problem instance of the planning problem;
selecting, by the system, an action with a maximum score from the respective scores of the set of applicable actions based on a subset of query tokens representing the problem instance; and
comparing, by the system, the action with a ground-truth action using a contrastive loss function to train the language model.

19. A computer program product for solving planning problems via language models, the computer program product comprising a computer readable storage medium having program instructions embodied therewith, the program instructions executable by a processor to cause the processor to:
receive, by the processor, a current state, a set of applicable actions, and a set of goal states that define a planning problem; and
generate, by the processor, via a language model, a plan for the planning problem, wherein generating the plan for the planning problem comprises:
generating, via an encoder, respective encoded representations of the current state, the set of applicable actions; and
evaluating, via a graph search algorithm, a set of plans based on the encoded representations.

20. The computer program product of claim 19, wherein the program instructions further cause the processor to:
determine, by the processor and using a similarity function, respective scores the set of applicable actions based on a similarity to the current state or the set of goal states
insert, by the processor, the set of applicable actions with the respective scores into a prioritized queue; and
select, by the processor, a next applicable action based on a maximum score of the respective scores.
